(19) United States
(12) Patent Application Publication
(10) Pub. No.: US 2022/0361536 A1
(43) Pub. Date: Nov. 17, 2022

(54) METHOD FOR KEEPING QUALITIES OF COOKED RICE AND METHOD FOR PRODUCING COOKED RICE

(71) Applicant: ORIENTAL YEAST CO., LTD., Tokyo (JP)

(72) Inventors: Takayasu TAKAHASHI, Tokyo (JP); Kosuke KIKUTA, Tokyo (JP); Shigeru YAMADA, Tokyo (JP)

(21) Appl. No.: 17/770,920

(22) PCT Filed: Oct. 14, 2020
(86) PCT No.: PCT/JP2020/038815

§ 371 Date: Apr. 21, 2022

(30) Foreign Application Priority Data
Oct. 24, 2019 (JP) 2019-193418

(51) Int. Cl. A23L 7/196

(52) U.S. Cl. CPC A23L 7/1963; A23L 7/1965; A23V 2002/00

(57) ABSTRACT

Provided are a method for keeping qualities of cooked rice and a method for producing cooked rice, including a step of bringing a polyvalent cation-containing liquid into contact with rice at any timing between before and after rice boiling or rice steaming, and a step of bringing an alginate-containing liquid into contact with the rice that contains a polyvalent cation and has been boiled or steamed.

### TECHNICAL FIELD

The present invention relates to a method for keeping qualities of cooked rice and a method for producing cooked rice.

### BACKGROUND ART

Due to, for example, diversification of consumers' lifestyles in recent years, there are increasing demands for products to be sold in, for example, convenience stores and supermarkets and using cooked rice that is refrigerated after boiled.

According to a proposed method for producing cooked rice having an excellent shape preservability that prevents, for example, cracking of rice and collapse of the surfaces of rice grains during heat sterilization or storage, raw rice is boiled together with a sodium alginate aqueous solution, the boiled rice is cooled and loosened, and then immersed in a polyvalent cation aqueous solution and then drained, and then the drained rice and water or a seasoning liquid are sterilized by heating (for example, see PTL 1).

According to a proposed technique for overcoming deterioration of texture of a rice dough-like food ingredient that can impart a glutinous texture and a flavor to, for example, freezable or refrigerable foods only by being mixed with the freezable or refrigerable foods, a glutinous rice composition, which is obtained by blending a glutinous rice flour, sugars, either or both of alginic acid and sodium alginate, and a poorly soluble calcium salt having a low solubility in water, is granulated under water adding and heating conditions until the glutinous rice composition becomes a predetermined pregelatinization degree, to prepare a glutinous rice processed product, and the glutinous rice processed product is then immersed in water to make the glutinous rice processed product absorb water, and then heated together with a sugar solution (for example, see PTL 2).

However, the proposed techniques are not intended to improve the texture and taste of cooked rice that is refrigerated after boiled. The products described above may experience a long distribution period depending on the districts. Also in this regard, it is required to better improve the texture and taste of cooked rice that is refrigerated after boiled.

Hence, under current circumstances, it is strongly demanded to provide a method for keeping qualities of cooked rice and a method for producing cooked rice, which can keep an appropriate softness and an appropriate fluffiness of cooked rice and can also make the cooked rice taste good even after the cooked rice is refrigerated after boiled.

### CITATION LIST

### Patent Literature

PTL 1: Japanese Patent Application Laid-Open No. 63-248360

PTL 2: Japanese Patent Application Laid-Open No. 2010-252661

### SUMMARY OF INVENTION

### Technical Problem

In response to these demands, the present invention aims for overcoming the current circumstances, solving the various problems in the related art, and achieving an object described below. That is, the present invention has an object to provide a method for keeping qualities of cooked rice and a method for producing cooked rice, which can keep an appropriate softness and an appropriate fluffiness of cooked rice and can also make the cooked rice taste good even after the cooked rice is refrigerated after boiled or steamed.

### Solution to Problem

As a result of conducting earnest studies in order to achieve the object described above, the present inventors have found it possible to keep an appropriate softness and an appropriate fluffiness of cooked rice and make the cooked rice taste good even after the cooked rice is refrigerated after boiled or steamed, by bringing an alginate-containing liquid into contact with boiled or steamed rice containing a polyvalent cation.

The present invention is based on the present inventors' finding described above, and means for solving the above problems are as follows.
<1> A method for keeping qualities of cooked rice, the method including:

a step of bringing a polyvalent cation-containing liquid into contact with rice at any timing between before and after rice boiling or rice steaming; and

a step of bringing an alginate-containing liquid into contact with the rice that contains a polyvalent cation and has been boiled or steamed.
<2> The method for keeping qualities of cooked rice according to <1>,

wherein the polyvalent cation-containing liquid is brought into contact with the rice during either or both of immersion and rice boiling.
<3> The method for keeping qualities of cooked rice according to <1>,

wherein the polyvalent cation-containing liquid contains a metal salt that is poorly water-soluble and forms a polyvalent cation at pH of 6.5 or lower, and

the polyvalent cation-containing liquid is brought into contact with the rice that has pH of 6.5 or lower and has been boiled or steamed.
<4> The method for keeping qualities of cooked rice according to <3>,

wherein the polyvalent cation-containing liquid and the alginate-containing liquid are one liquid.
<5> The method for keeping qualities of cooked rice according to any one of <1> to <4>,

wherein with respect to 100 parts by mass of raw rice, an amount of the polyvalent cation is 0.01 parts by mass or greater, and an amount of an alginate is 0.01 parts by mass or greater.
<6> The method for keeping qualities of cooked rice according to any one of <1> to <5>,

wherein from 1 part by mass to 50 parts by mass of the alginate-containing liquid is brought into contact with 100 parts by mass of the rice that has been boiled or steamed.
<7> The method for keeping qualities of cooked rice according to any one of <1> to <6>,

wherein a concentration of an alginate in the alginate-containing liquid is from 0.05% by mass to 5% by mass.
<8> A method for producing cooked rice, the method including;

a step of bringing a polyvalent cation-containing liquid into contact with rice at any timing between before and after rice boiling or rice steaming; and

a step of bringing an alginate-containing liquid into contact with the rice that contains a polyvalent cation and has been boiled or steamed.
<9> The method for producing cooked rice according to <8>,

wherein the polyvalent cation-containing liquid is brought into contact with the rice during either or both of immersion and rice boiling.
<10> The method for producing cooked rice according to <8>,

wherein the polyvalent cation-containing liquid contains a metal salt that is poorly water-soluble and forms a polyvalent cation at pH of 6.5 or lower, and

the polyvalent cation-containing liquid is brought into contact with the rice that has pH of 6.5 or lower and has been boiled or steamed.
<11> The method for producing cooked rice according to <10>,

wherein the polyvalent cation-containing liquid and the alginate-containing liquid are one liquid.
<12> The method for producing cooked rice according to any one of <8> to <11>,

wherein with respect to 100 parts by mass of raw rice, an amount of the polyvalent cation is 0.01 parts by mass or greater, and an amount of an alginate is 0.01 parts by mass or greater.
<13> The method for producing cooked rice according to any one of <8> to <12>,

wherein from 1 part by mass to 50 parts by mass of the alginate-containing liquid is brought into contact with 100 parts by mass of the rice that has been boiled or steamed.
<14> The method for producing cooked rice according to any one of <8> to <13>,

wherein a concentration of an alginate in the alginate-containing liquid is from 0.05% by mass to 5% by mass.

### Advantageous Effects of Invention

The present invention can solve the various problems in the related art and provide a method for keeping qualities of cooked rice and a method for producing cooked rice, which can keep an appropriate softness and an appropriate fluffiness of cooked rice and can also make the cooked rice taste good even after the cooked rice is refrigerated after boiled or steamed.

### DESCRIPTION OF EMBODIMENTS

### (Method for Keeping Qualities of Cooked Rice)

A method for keeping qualities of cooked rice (hereinafter, may be referred to as “quality keeping method”) according to the present invention includes at least a first contact step and a second contact step, and further includes other steps as needed.

### <First Contact Step>

The first contact step is a step of bringing a polyvalent cation-containing liquid into contact with rice at any timing between before and after rice boiling or rice steaming.

Through this step, rice can contain a polyvalent cation in either or both of an interior and a surface thereof. In the present specification, examples of the form of “the rice containing a polyvalent cation” include a form in which a polyvalent cation is present in the interior of the rice, a form in which a polyvalent cation is present in the surface of the rice, and a form in which a polyvalent cation is present in both of the interior and the surface of the rice.

### —Polyvalent Cation-Containing Liquid—

The polyvalent cation-containing liquid contains at least a polyvalent cation and further contains other components as needed.

The polyvalent cation-containing liquid may contain a metal salt that is poorly water-soluble and forms a polyvalent cation at pH of 6.5 or lower.

The polyvalent cation is not particularly limited and may be appropriately selected so long as the polyvalent cation is of a grade that can be used for foods and beverages. Examples of the polyvalent cation include a calcium ion, an iron ion, a magnesium ion, a zinc ion, and a copper ion. One of these polyvalent cations may be used alone or two or more of these polyvalent cations may be used in combination.

Among these polyvalent cations, a calcium ion is preferable because a gel formed when an alginate-containing liquid described below is brought into contact with the calcium ion has an excellent stability.

The polyvalent cation can be formed when a metal salt is added in a solvent such as water.

The metal salt is not particularly limited and may be appropriately selected so long as the metal salt is of a grade that can be used for foods and beverages. Examples of the metal salt include: calcium salts such as calcium lactate, calcium chloride, calcium acetate, calcium sulfate, and tricalcium phosphate; iron salts such as ferric chloride, sodium ferrous citrate, iron citrate, iron ammonium citrate, ferrous gluconate, iron lactate, and ferrous sulfate; magnesium salts such as magnesium chloride, magnesium carbonate, magnesium sulfate, magnesium oxide, magnesium L-glutamate, magnesium stearate, trimagnesium phosphate, and magnesium hydroxide; and zinc salts such as zinc gluconate and zinc sulfate. One of these metal salts may be used alone or two or more of these metal salts may be used in combination. A dolomite aqueous solution obtained by dissolving dolomite (calcium magnesium carbonate: CaMg(CO₃)₂) in an organic acid aqueous solution and solubilizing dolomite in water may also be used.

As the metal salt, a commercially available product may be appropriately used.

The metal salt that is poorly water-soluble and forms a polyvalent metal salt at pH of 6.5 or lower is not particularly limited and may be appropriately selected so long as such a metal salt is of a grade that can be used for foods and beverages. Examples of the metal salt that is poorly water-soluble and forms a polyvalent metal salt at pH of 6.5 or lower include calcium carbonate, calcium hydroxide, and calcium citrate, or materials containing any of these metal salts (for example, burned calcium and dolomite). One of these metal salts may be used alone or two or more of these metal salts may be used in combination.

In the present specification, a poorly water-soluble metal salt represents a metal salt having a solubility lower than or equal to 200 mg/100 g of water.

As the metal salt that is poorly water-soluble and forms a polyvalent cation at pH of 6.5 or lower, a commercially available product may be appropriately used.

The amount of the polyvalent cation to be used is not particularly limited, may be appropriately selected, and is preferably 0.01 parts by mass or greater, more preferably 0.06 parts by mass or greater, and particularly preferably 0.09 parts by mass or greater relative to 100 parts by mass of raw rice. In the preferable range, there is an advantage that cooked rice after refrigerated can have even better hardness and taste.

The concentration of the polyvalent ion in the polyvalent cation-containing liquid is not particularly limited and may be appropriately selected depending on, for example, the amount of the polyvalent cation to be used.

The other components in the polyvalent cation-containing liquid are not particularly limited and may be appropriately selected. Examples of the other components include amino acids, organic acids, sugars, fermented seasonings, salts, and spices. One of these components may be used alone or two or more of these components may be used in combination.

The content of the other components in the polyvalent cation-containing liquid is not particularly limited and may be appropriately selected.

The form of the polyvalent cation-containing liquid is not particularly limited and may be appropriately selected. Examples of the form of the polyvalent cation-containing liquid include a form in which the polyvalent cation is added to water that is used either or both of before heating and during heating, such as immersion water or rice boiling water, and a form in which the polyvalent cation is added to a liquid such as water and a seasoning, to be used for rice after boiled or steamed (heated).

The amount of the polyvalent cation-containing liquid to be used is not particularly limited and may be appropriately selected depending on, for example, the form of use of the polyvalent cation-containing liquid. For example, when immersion water or rice boiling water is used as the polyvalent cation-containing liquid, the amount of the polyvalent cation-containing liquid to be used may be about from 100 parts by mass to 150 parts by mass relative to 100 parts by mass of raw rice. When the polyvalent cation-containing liquid is used for rice after boiled or steamed (heated), the amount of the polyvalent cation-containing liquid to be used may be about from 1 part by mass to 50 parts by mass relative to 100 parts by mass of rice after boiled or steamed.

When a liquid containing the metal salt that is poorly water-soluble and forms a polyvalent cation at pH of 6.5 or lower is used as the polyvalent cation-containing liquid, the polyvalent cation-containing liquid may be free of, or contain an alginate described below.

When the polyvalent cation-containing liquid contains the metal salt that is poorly water-soluble and forms a polyvalent cation at pH of 6.5 or lower, and the alginate, that is, when the metal salt that forms a polyvalent cation at pH of 6.5 or lower and the alginate are contained in the same liquid (i.e., the polyvalent cation-containing liquid and the alginate-containing liquid are one liquid), pH of the liquid is maintained at pH higher than 6.5 in order that the metal salt that is poorly water-soluble does not ionize until contact with rice that has pH of 6.5 or lower and has been boiled or steamed. Then, by contact with rice that has pH of 6.5 or lower and has been boiled or steamed, the metal salt that is poorly water-soluble ionizes and forms a polyvalent cation (first contact step). Subsequently, by reaction with the alginate contained in the liquid (second contact step), the polyvalent cation forms a gel.

For example, the amount of the polyvalent cation to be used and the concentration of the polyvalent cation when the polyvalent cation-containing liquid and the alginate-containing liquid are one liquid may be the same values as described above. For example, the amount of the alginate to be used and the concentration of the alginate may be the same values as will be described in the section—Alginate-containing liquid— below.

When the polyvalent cation-containing liquid and the alginate-containing liquid are one liquid, the amount of the liquid to be used may be the same value as the amount of the alginate-containing liquid to be used described below.

### —Rice—

The form of the rice is not particularly limited and may be appropriately selected. Examples of the form of the rice include raw rice before boiled or steamed (before heated), rice being boiled (being heated), and rice after boiled or steamed (heated).

The rice is not particularly limited and may be appropriately selected. Examples of the rice include ordinary rice and glutinous rice. The species of the rice is not particularly limited and may be appropriately selected. Examples of the species of the rice include Japonica and Indica. The breed of the rice is not particularly limited and may be appropriately selected. Examples of the breed of the rice include Akitakomachi, Koshihikari, Sasanishiki, Hitomebore, and Calrose. No-wash rice may also be used as the rice.

In the first contact step, food ingredients other than the rice (e.g., seasonings such as sugars, sweeteners, salts, peppers, vinegars, soy sauces, fermented soybean pastes, soup stocks, consomme, sodium glutamate, and ketchups; ingredients such as vegetables, mushrooms, konjak, fried tofu, meats, seafood, seaweeds, and beans; and spices such as curry powder, peppers, and saffron) may be added.

### —Contact—

The method for bringing the polyvalent cation-containing liquid into contact with the rice is not particularly limited and may be appropriately selected. Examples of the method include a method of spraying, applying, or dropping the polyvalent cation-containing liquid to the rice, and a method of immersing the rice in the polyvalent cation-containing liquid. One of these methods may be used alone or two or more of these methods may be used in combination. For example, mixing and stirring may also be performed as needed.

The timing at which the polyvalent cation-containing liquid is brought into contact with the rice is not particularly limited and may be appropriately selected. When a polyvalent cation-containing liquid in which a polyvalent cation has been formed before contact with the rice is used as the polyvalent cation-containing liquid, examples of the timing include a timing during either or both of immersion and rice boiling, and a timing after rice boiling or rice steaming. Among these timings, a timing during either or both of immersion and rice boiling is preferable because the polyvalent cation-containing liquid permeates the rice and is distributed in the rice uniformly when the polyvalent cation-containing liquid is added at the timing.

When a polyvalent cation-containing liquid containing the metal salt that is poorly water-soluble and forms a polyvalent cation at pH of 6.5 or lower is used as the polyvalent cation-containing liquid, the polyvalent cation-containing liquid is brought into contact with rice that has pH of 6.5 or lower and has been boiled or steamed. The method for adjusting pH of the rice is not particularly limited and may be appropriately selected. Examples of the method include a method of adding, for example, a brewed vinegar during rice boiling or rice steaming, and a method of adding, for example, a brewed vinegar after rice boiling or rice steaming. pH is not particularly limited and may be appropriately selected so long as pH is 6.5 or lower.

The conditions such as temperature and time for bringing the polyvalent cation-containing liquid into contact with rice are not particularly limited and may be appropriately selected depending on, for example, the form of the polyvalent cation-containing liquid.

The first contact step may be performed once, or a plurality of times dividedly.

The method and conditions for rice boiling or rice steaming are not particularly limited. A known method and known conditions may be appropriately selected.

In the present specification, rice boiling means heating rice by immersing the rice directly in water, and rice steaming means heating rice via a steam without immersing the rice directly in water.

### <Second Contact Step>

The second contact step is a step of bringing an alginate-containing liquid into contact with the rice that contains a polyvalent cation and has been boiled or steamed.

Through this step, a gel is formed in either or both of an interior and a surface of the rice.

### —Alginate-Containing Liquid—

The alginate-containing liquid contains at least an alginate and further contains other components as needed.

As described above, when a polyvalent cation-containing liquid containing the metal salt that is poorly water-soluble and forms a polyvalent cation at pH of 6.5 or lower is used as the polyvalent cation-containing liquid, the alginate-containing liquid and the polyvalent cation-containing liquid may be one liquid.

The alginate is not particularly limited and may be appropriately selected. Examples of the alginate include sodium alginate and potassium alginate. One of these alginates may be used alone or two or more of these alginates may be used in combination.

As the alginate, a commercially available product may be appropriately used.

The amount of the alginate to be used is not particularly limited, may be appropriately selected, and is preferably 0.01 parts by mass or greater, more preferably 0.04 parts by mass or greater, yet more preferably 0.06 parts by mass or greater, and particularly preferably 0.09 parts by mass or greater relative to 100 parts by mass of raw rice. In the preferable range, there is an advantage that cooked rice after refrigerated can have even better hardness and taste. The upper limit of the amount of the alginate to be used may be appropriately selected considering a handling aptitude.

The concentration of the alginate in the alginate-containing liquid is not particularly limited, may be appropriately selected, and is preferably from 0.05% by mass to 5% by mass, more preferably from 0.1% by mass to 4% by mass, yet more preferably from 0.2% by mass to 4% by mass, and particularly preferably from 0.3% by mass to 3% by mass. In the preferable range, there is an advantage that cooked rice after refrigerated can have even better hardness and taste.

The other components of the alginate-containing liquid are not particularly limited and may be appropriately selected. Examples of the other components include the components that are the same as the other components of the polyvalent cation-containing liquid described above.

The content of the other components in the alginate-containing liquid is not particularly limited and may be appropriately selected.

The form of the alginate-containing liquid is not particularly limited and may be appropriately selected. Examples of the form of the alginate-containing liquid include a form in which the alginate is dissolved in water, and a form in which the alginate is dissolved in a liquid seasoning such as a seasoned vinegar for preparing sushi.

The amount of the alginate-containing liquid to be used is not particularly limited, may be appropriately selected, and is preferably from 1 part by mass to 50 parts by mass, more preferably from 5 parts by mass to 30 parts by mass, and particularly preferably from 10 parts by mass to 20 parts by mass relative to 100 parts by mass of rice that has been boiled or steamed. In the preferable range, there is an advantage that cooked rice after refrigerated can have even better hardness and taste.

### —Contact—

The method for bringing the alginate-containing liquid into contact with rice that contains a polyvalent cation and has been boiled or steamed is not particularly limited and may be appropriately selected. Examples of the method include the same methods as the methods for bringing the polyvalent cation-containing liquid into contact with rice described above.

The timing at which the alginate-containing liquid is brought into contact with rice that contains a polyvalent cation and has been boiled or steamed is not particularly limited and may be appropriately selected so long as the timing is after the polyvalent cation has been added to the rice and the rice had been boiled or steamed.

The conditions such as temperature and time for bringing the alginate-containing liquid into contact with the rice that contains a polyvalent cation and has been boiled or steamed are not particularly limited and may be appropriately selected depending on, for example, the form of the alginate-containing liquid.

The second contact step may be performed once, or a plurality of times dividedly.

### <Other Steps>

The other steps are not particularly limited so long as the effect of the present invention is not spoiled, and steps of known methods for producing cooked rice may be appropriately selected. Examples of the other steps include a rice washing step.

### <Cooked Rice>

The cooked rice is not particularly limited and may be appropriately selected. Examples of the cooked rice include white rice, and cooked and processed rice such as vinegared rice, rice steamed with red beans, rice boiled with ingredients, mugimeshi obtained by boiling white rice and barley together, sticky rice obtained by boiling or steaming polished glutinous rice, rice boiled in tea, and rice containing ingredients such as chestnuts or beans. The cooked rice may be used as the material for traditional Japanese sweets using rice, such as ohagi (a rice ball coated with sweetened red beans, soybean flour, or sesame and salt).

The quality keeping method of the present invention can keep an appropriate softness and an appropriate fluffiness of boiled or steamed rice, and can also make the boiled or steamed rice taste good even after the boiled or steamed rice is refrigerated after boiled or steamed.

### (Method for Producing Cooked Rice)

A method for producing cooked rice (hereinafter may be referred to as “producing method”) according to the present invention includes at least a first contact step and a second contact step, and further includes other steps as needed.

### <First Contact Step>

The first contact step is a step of bringing a polyvalent cation-containing liquid into contact with rice at any timing between before and after rice boiling or rice steaming, and can be performed in the same manner as <First contact step> of (Method for keeping qualities of cooked rice) described above.

### <Second Contact Step>

The second contact step is a step of bringing an alginate-containing liquid into contact with rice that contains a polyvalent cation and has been boiled or steamed, and can be performed in the same manner as <Second contact step> of (Method for keeping qualities of cooked rice) described above.

### <Other Steps>

The other steps are not particularly limited and may be appropriately selected so long as the effect of the present invention is not spoiled. Examples of the other steps include the same steps as described in the section <Other steps> of (Method for keeping qualities of cooked rice) described above.

### <Cooked Rice>

The cooked rice is the same as <Cooked rice> of (Method for keeping qualities of cooked rice) described above.

The producing method of the present invention can produce cooked rice that keeps an appropriate softness and an appropriate fluffiness and also tastes good even after the cooked rice is refrigerated after boiled or steamed.

### EXAMPLES

The present invention will be described below by way of Test Examples. The present invention should not be construed as being limited to these Test Examples.

### Test Example 1

To raw rice (Akitakomachi) (100 parts by mass), water (135 parts by mass) was added, and calcium lactate (pentahydrate) (obtained from Taihei Chemical Industrial Co., Ltd.) was further added and mixed in the amounts described in Table 1 and dissolved. After the raw rice was immersed for 30 minutes, the raw rice was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), an alginate aqueous solution (15.0 parts by mass) in which the concentration of sodium alginate (KIMICA ALGINE I-3, obtained from KIMICA Corporation) was 1.0% by mass was added and mixed.

The obtained cooked rice (white rice) was refrigerated at 3° C.

Cooked rice produced in the same manner except that calcium lactate and the alginate aqueous solution were not added was tested in the same manner.

### <Evaluation>

### —Sensory Evaluation—

After storage at 3° C. for 2 days, the cooked rice (20 g) was eaten as it was, and evaluated according to the evaluation criteria described below. Ten persons joined the evaluation. For “hardness”, the average of the evaluation results is presented in Table 1. For “amount of water”, the evaluation result adopted the most is presented in Table 1.

### [Evaluation Criteria]

### —Hardness—

5 points: The cooked rice was adequately soft and fluffy.

4 points: The cooked rice was soft and slightly fluffy.

3 points: The cooked rice was slightly soft and weakly fluffy.

2 points: The cooked rice was slightly hard and crumbly.

1 point: The cooked rice was hard and crumbly.

### —Amount of Water—

A: The cooked rice contained an adequate amount of water.

B: The cooked rice contained a slightly high amount of water, or a slightly low amount of water.

C: The cooked rice contained a high amount of water, or a low amount of water.

### —Measurement—

Hardness of the cooked rice after stored at 3° C. for 2 days was measured using a creep meter under the measuring conditions described below. The results are presented in Table 1.

### [Measuring Conditions]

Plunger: circular (with a diameter of 1 cm)

Measuring speed: 0.5 mm/sec

A load at a distortion factor of 60% was used as hardness (N)

TABLE 1

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 1-1 | — | — | — | — | — | 1.0 | C | 6.3 |
| 1-2 | 3.3 | 0.43 | 1.0 | 15.0 | 0.33 | 4.0 | A | 3.9 |
| 1-3 | 0.66 | 0.086 | 1.0 | 15.0 | 0.33 | 4.0 | A | 3.9 |
| 1-4 | 0.44 | 0.057 | 1.0 | 15.0 | 0.33 | 3.0 | B | 4.6 |
| 1-5 | 0.11 | 0.014 | 1.0 | 15.0 | 0.33 | 2.0 | C | 6.8 |

### Test Example 2

Cooked rice (white rice) was produced, stored, and evaluated in the same manner as in Test Example 1, except that the amount of calcium lactate (pentahydrate) relative to 100 parts by mass of raw rice was changed to 1.1 parts by mass, and the concentration of sodium alginate in the alginate aqueous solution was changed to the concentrations described in Table 2. The results are presented in Table 2.

TABLE 2

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 2-1 | — | — | — | — | — | 1.0 | C | 6.3 |
| 2-2 | 1.1 | 0.14 | 2.0 | 15.0 | 0.66 | 5.0 | A | 3.6 |
| 2-3 | 1.1 | 0.14 | 0.3 | 15.0 | 0.099 | 5.0 | A | 4.0 |
| 2-4 | 1.1 | 0.14 | 0.2 | 15.0 | 0.066 | 3.0 | B | 4.3 |
| 2-5 | 1.1 | 0.14 | 0.1 | 15.0 | 0.033 | 2.0 | C | 4.8 |
| 2-6 | 1.1 | 0.14 | 0.05 | 15.0 | 0.017 | 2.0 | C | 5.1 |

### Test Example 3

Cooked rice (white rice) was produced, stored, and evaluated in the same manner as in Test Example 1, except that the amount of calcium lactate (pentahydrate) relative to 100 parts by mass of raw rice was changed to 1.1 parts by mass, and the amount of the alginate aqueous solution added was changed to the amounts described in Table 3. The results are presented in Table 3.

TABLE 3

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 3-1 | — | — | — | — | — | 1.0 | C | 6.9 |
| 3-2 | 1.1 | 0.14 | 1.0 | 1.0 | 0.02 | 2.0 | C | 5.4 |
| 3-3 | 1.1 | 0.14 | 1.0 | 5.0 | 0.11 | 3.0 | A | 3.5 |
| 3-4 | 1.1 | 0.14 | 1.0 | 10.0 | 0.22 | 4.0 | A | 4.3 |
| 3-5 | 1.1 | 0.14 | 1.0 | 15.0 | 0.33 | 5.0 | A | 4.2 |
| 3-6 | 1.1 | 0.14 | 1.0 | 20.0 | 0.44 | 5.0 | A | 4.0 |
| 3-7 | 1.1 | 0.14 | 1.0 | 25.0 | 0.55 | 4.0 | B | 3.6 |
| 3-8 | 1.1 | 0.14 | 1.0 | 30.0 | 0.66 | 4.0 | B | 3.4 |
| 3-9 | 1.1 | 0.14 | 1.0 | 50.0 | 1.1 | 4.0 | C | 3.1 |

### Test Example 4

Cooked rice (white rice) was produced and stored in the same manner as in Test Example 1, except that the amount of calcium lactate (pentahydrate) relative to 100 parts by mass of raw rice was changed to 1.1 parts by mass, and the amount of the alginate aqueous solution added was changed to the amounts described in Table 4.

### <Evaluation>

After the cooked rice was stored at 3° C. for 6 days, the cooked rice (20 g) was microwaved (at 500 W for 30 seconds). Sensory evaluation and hardness measurement of the microwaved cooked rice (white rice) were performed in the same manner as in Test Example 1. The results are presented in Table 4.

TABLE 4

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 4-1 | — | — | — | — | — | 2.0 | C | 5.0 |
| 4-2 | 1.1 | 0.14 | 1.0 | 10.0 | 0.22 | 5.0 | A | 3.0 |
| 4-3 | 1.1 | 0.14 | 1.0 | 15.0 | 0.33 | 5.0 | A | 3.0 |
| 4-4 | 1.1 | 0.14 | 1.0 | 20.0 | 0.44 | 5.0 | A | 2.7 |

### Test Example 5

To raw rice (Akitakomachi) (100 parts by mass), water (135 parts by mass) was added, and calcium lactate (pentahydrate) (obtained from Taihei Chemical Industrial Co., Ltd.) was further added and mixed in the amounts described in Table 5 and dissolved. After the raw rice was immersed for 30 minutes, the raw rice was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), a seasoned vinegar for preparing sushi (11 parts by mass) (brewed vinegar: 6.0 parts by mass, sugar: 4.0 parts by mass, and salt: 1.0 part by mass) was added and mixed. Next, to the boiled rice (100 parts by mass), an alginate aqueous solution (10.0 parts by mass) in which the concentration of sodium alginate (KIMICA ALGINE I-3, obtained from KIMICA Corporation) was 1.0% by mass was added and mixed.

The obtained cooked rice (vinegared rice) was refrigerated at 3° C.

Cooked rice produced in the same manner except that calcium lactate and the alginate aqueous solution were not added was tested in the same manner.

### <Evaluation>

Sensory evaluation and hardness measurement were performed in the same manner as in Test Example 1, except that the cooked rice (vinegared rice) was stored at 3° C. for 4 days. The results are presented in Table 5.

TABLE 5

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 5-1 | — | — | — | — | — | 2.0 | C | 6.2 |
| 5-2 | 3.3 | 0.43 | 1.0 | 10.0 | 0.22 | 4.0 | A | 3.9 |
| 5-3 | 0.66 | 0.086 | 1.0 | 10.0 | 0.22 | 4.0 | A | 3.8 |
| 5-4 | 0.44 | 0.057 | 1.0 | 10.0 | 0.22 | 4.0 | A | 4.5 |
| 5-5 | 0.11 | 0.014 | 1.0 | 10.0 | 0.22 | 2.0 | B | 4.9 |

### Test Example 6

Vinegared rice was produced, stored, and evaluated in the same manner as in Test Example 5, except that the amount of calcium lactate (pentahydrate) relative to 100 parts by mass of raw rice was changed to 1.1 parts by mass, and the concentration of sodium alginate in the alginate aqueous solution was changed to the concentrations described in Table 6. The results are presented in Table 6.

TABLE 6

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 6-1 | — | — | — | — | — | 2.0 | C | 5.6 |
| 6-2 | 1.1 | 0.14 | 2.0 | 10.0 | 0.44 | 4.0 | A | 3.3 |
| 6-3 | 1.1 | 0.14 | 0.4 | 10.0 | 0.088 | 5.0 | A | 3.4 |
| 6-4 | 1.1 | 0.14 | 0.3 | 10.0 | 0.066 | 4.0 | A | 3.3 |
| 6-5 | 1.1 | 0.14 | 0.2 | 10.0 | 0.044 | 4.0 | A | 3.8 |
| 6-6 | 1.1 | 0.14 | 0.1 | 10.0 | 0.022 | 4.0 | B | 4.0 |
| 6-7 | 1.1 | 0.14 | 0.05 | 10.0 | 0.011 | 3.0 | B | 4.7 |

### Test Example 7

Vinegared rice was produced, stored, and evaluated in the same manner as in Test Example 5, except that the amount of calcium lactate (pentahydrate) relative to 100 parts by mass of raw rice was changed to 1.1 parts by mass, and the amount of the alginate aqueous solution added was changed to the amounts described in Table 7. The results are presented in Table 7.

TABLE 7

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 7-1 | — | — | — | — | — | 2.0 | C | 5.6 |
| 7-2 | 1.1 | 0.14 | 1.0 | 10.0 | 0.22 | 4.0 | A | 3.0 |
| 7-3 | 1.1 | 0.14 | 1.0 | 15.0 | 0.33 | 5.0 | A | 3.0 |

### Test Example 8

Raw rice was boiled in the same manner as in Test Example 5, except that the amount of calcium lactate (pentahydrate) relative to 100 parts by mass of raw rice was changed to 1.1 parts by mass.

To the boiled rice (100 parts by mass), a mixture of: a seasoned vinegar for preparing sushi (11 parts by mass) (brewed vinegar: 6.0 parts by mass, sugar: 4.0 parts by mass, and salt: 1.0 part by mass); and an alginate aqueous solution (10.0 parts by mass) in which the concentration of sodium alginate (KIMICA ALGINE I-3, obtained from KIMICA Corporation) was 1.0% by mass was added and mixed.

The produced vinegared rice was stored and evaluated in the same manner as in Test Example 5.

As a result, the hardness scored 4.0 points and the amount of water was rated B in the sensory measurement, and the hardness measured 3.8 N.

### Test Example 9

Raw rice (Akitakomachi) (100 parts by mass) was immersed in a calcium lactate solution having a concentration of 3% by mass and prepared in an amount equal to or greater than the water absorbable amount of the raw rice. The water absorbing ratio of raw rice is 130% by mass. Therefore, the raw rice (100 parts by mass) became 130 parts by mass after immersion. After the raw rice immersed in the calcium lactate solution was drained, water was added in a manner that the amount of water would be adjusted to 135 parts by mass relative to 100 parts by mass of the raw rice. The raw rice to which water was added to adjust the amount of water was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), an alginate aqueous solution (15.0 parts by mass) in which the concentration of sodium alginate (KIMICA ALGINE I-3, obtained from KIMICA Corporation) was 1.0% by mass was added and mixed (Test Example 9-2). In a control, cooked rice was produced in the same manner except that calcium lactate and the alginate aqueous solution were not added (Test Example 9-1).

After the obtained cooked rice (white rice) was stored at 3° C. for 2 days, the cooked rice was evaluated in the same manner as in Test Example 1. The results are presented in Table 8.

TABLE 8

| | Concentration | | | Amount of | | | | |
|---|---|---|---|---|---|---|---|---|
| | of | Amount of | | alginate | | | | |
| | calcium | calcium | | aqueous | Amount of | | | |
| | lactate in | ion | | solution | alginate | | | |
| | calcium | relative to | Concentration | relative to | relative to | | | |
| | lactate | 100 parts | of alginate | 100 parts | 100 parts | Evaluation | | |
| | aqueous | by mass of | in alginate | by mass of | by mass of | Sensory | | |
| | solution | raw rice | aqueous | boiled rice | raw rice | evaluation | | |
| Test | (% by | (part by | solution | (part by | (part by | | Amount | Measurement |
| Ex. No. | mass) | mass) | (% by mass) | mass) | mass) | Hardness | of water | Hardness (N) |
| 9-1 | — | — | — | — | — | 1.0 | C | 6.3 |
| 9-2 | 3.0 | 0.12 | 1.0 | 15.0 | 0.33 | 5.0 | A | 3.5 |

From the results of Test Example 9, it was confirmed that also when raw rice was boiled after a polyvalent cation was added to the raw rice through use of polyvalent cation-containing water as immersion water and the raw rice was drained, similar results to the cases where polyvalent cation-containing water was used as rice boiling water were obtained.

### Test Example 10

To raw rice (Akitakomachi) (100 parts by mass), water (135 parts by mass) was added to immerse the raw rice for 30 minutes. Subsequently, the raw rice was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), a seasoned vinegar for preparing sushi (11 parts by mass) (brewed vinegar: 6.0 parts by mass, sugar: 4.0 parts by mass, and salt: 1.0 part by mass) was added and mixed (pH of the vinegared rice: about 4.5). Next, to the boiled rice (100 parts by mass), a calcium carbonate and alginic acid-containing liquid (10.0 parts by mass or 15.0 parts by mass) in which the concentration of calcium carbonate (obtained from Shiraishi Calcium Kaisha, Ltd.) was 0.25% by mass and the concentration of sodium alginate (KIMICA ALGINE I-3, obtained from KIMICA Corporation) was 1.0% by mass (pH of the calcium carbonate and alginic acid-containing liquid: about 8, calcium carbonate not dissolved) was added and mixed.

In a control, cooked rice was produced in the same manner except that the calcium carbonate and alginic acid-containing liquid was not added (Test Example 10-1).

The obtained cooked rice (vinegared rice) was evaluated in the same manner as in Test Example 5. The results are presented in Table 9.

TABLE 9

| | | | | Amount of | | | | |
|---|---|---|---|---|---|---|---|---|
| | | | | calcium | | | | |
| | | | | carbonate and | | | | |
| | Amount of | Amount of | Concentration | alginate- | | | | |
| | calcium | calcium | of alginate | containing | Amount of | | | |
| | carbonate | ion | in calcium | liquid | alginate | | | |
| | relative to | relative to | carbonate and | relative to | relative to | | | |
| | 100 parts | 100 parts | alginate- | 100 parts | 100 parts | Evaluation | | |
| | by mass of | by mass of | containing | by mass of | by mass of | Sensory | | |
| | raw rice | raw rice | liquid | boiled rice | raw rice | evaluation | | |
| Test | (part by | (part by | (% by | (part by | (part by | | Amount | Measurement |
| Ex. No. | mass) | mass) | mass) | mass) | mass) | Hardness | of water | Hardness (N) |
| 10-1 | — | — | — | — | — | 2.0 | C | 5.9 |
| 10-2 | 0.25 | 0.1 | 1.0 | 10.0 | 0.22 | 4.0 | A | 2.9 |
| 10-3 | 0.25 | 0.1 | 1.0 | 15.0 | 0.33 | 5.0 | A | 2.9 |

From the results of Test Example 10, it was confirmed that also when a metal salt that is poorly water-soluble and forms a polyvalent cation at pH of 6.5 or lower was used, similar results to Test Examples described above were obtained. This is considered due to that rice that contained a polyvalent cation and had been boiled or steamed was formed by ionization of calcium carbonate, which is an example of the metal salt that is poorly water-soluble and forms a polyvalent cation at pH of 6.5 or lower, by contact with the vinegared rice, which is an example of the rice that has pH of 6.5 or lower and has been boiled or steamed, and the rice thus formed subsequently reacted with the alginate to form a gel and produce the intended effect.

From the results described above, the cooked rice produced by the method of the present invention had an appropriate softness and an appropriate fluffiness, had preserved a solid shape, and also had an appropriate graininess. Further, it was demonstrated that the cooked rice produced by the method of the present invention had an appropriate hardness not only when it was microwaved but also when it was not microwaved, and could be eaten as it was. Moreover, in terms of taste, it was confirmed that the cooked rice produced by the method of the present invention had the same taste as that that is intrinsic to cooked rice, and that the present invention did not adversely affect the taste and was able to provide cooked rice having a good taste.

The cooked rice produced by the method of the present invention did not become watery and had an appropriate hardness even when water was added after it was boiled, and could be molded into shapes of, for example, rice balls and sushi even after refrigerated. Therefore, it would be possible to distribute the cooked rice produced by the method of the present invention at a low temperature in a molded state, or to mold the cooked rice produced by the method of the present invention to a desired shape after distributing the cooked rice at a low temperature in an unmolded state.

In a production process of rice balls, there may be a case where an oil is added in order to impart loosenability to cooked rice. The cooked rice produced by the method of the present invention has loosenability that does not need an oil for imparting loosenability, and could be produced to rice balls without influences on the taste.

### Test Example 11

Vinegared rice was produced, stored, and evaluated in the same manner as in Test Example 5, except that the amount of calcium lactate (pentahydrate) relative to 100 parts by mass of raw rice and addition of an alginate aqueous solution were changed to (i) or (ii) below. In Test Example 11-1, vinegared rice was produced in the same manner except that calcium lactate and the alginate aqueous solution were not added. The results are presented in Table 10.

(i) Calcium lactate (pentahydrate) was not added, and water (10 parts by mass) was added instead of an alginate aqueous solution (Text Example 11-2).

(ii) The amount of calcium lactate (pentahydrate) relative to 100 parts by mass of raw rice was 0.88 parts by mass, and an alginate aqueous solution (10 parts by mass) having a sodium alginate concentration of 0.4% by mass was added (Test Example 11-3).

TABLE 10

| | | | | Amount of | | | | |
|---|---|---|---|---|---|---|---|---|
| | Amount of | Amount of | | alginate | | | | |
| | calcium | calcium | | aqueous | Amount of | | | |
| | lactate | ion | | solution | alginate | | | |
| | relative to | relative to | Concentration | relative to | relative to | | | |
| | 100 parts | 100 parts | of alginate | 100 parts | 100 parts | Evaluation | | |
| | by mass of | by mass of | in alginate | by mass of | by mass of | Sensory | | |
| | raw rice | raw rice | aqueous | boiled rice | raw rice | evaluation | | |
| Test | (part by | (part by | solution | (part by | (part by | | Amount | Measurement |
| Ex. No. | mass) | mass) | (% by mass) | mass) | mass) | Hardness | of water | Hardness (N) |
| 11-1 | — | — | — | — | — | 2.0 | C | 5.7 |
| 11-2* | — | — | — | — | — | 2.0 | C | 4.1 |
| 11-3 | 0.88 | 0.11 | 0.4 | 10.0 | 0.088 | 4.0 | A | 3.9 |

*In Test Example11-2, water (10 parts by mass) was added to boiled rice (100 parts by mass).

As demonstrated in Test Example 11, the cooked rice produced by the method of the present invention did not become watery and had an appropriate hardness even when water was added after it was boiled, whereas when water was simply added after rice was boiled, the cooked rice thus obtained contained a high amount of water and was watery and could not be molded into shapes of, for example, rice balls and sushi.

### Test Example 12

To raw rice (Akitakomachi) (100 parts by mass), water (135 parts by mass) containing an alginate was added (the amount of the alginate relative to 100 parts by mass of raw rice: 0.15 parts by mass). After the raw rice immersed for 30 minutes, the raw rice was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), a calcium lactate aqueous solution (15.0 ₚarts by mass) having a concentration of 3.0% by mass (the amount of calcium ion relative to 100 parts by mass of raw rice: 0.13 parts by mass) was added and mixed (Test Example 12-2). In a control, cooked rice was produced in the same manner except that calcium lactate and the alginate aqueous solution were not added (Test Example 12-1).

The obtained cooked rice (white rice) was stored at 3° C. for 2 days, and subsequently evaluated in the same manner as in Test Example 1. The results are presented in Table 11.

TABLE 11

| | | | Amount of | | | | |
|---|---|---|---|---|---|---|---|
| | | Concentration | calcium | Amount of | | | |
| | Amount of | of calcium | lactate | calcium | | | |
| | alginate | lactate in | solution | ion | | | |
| | relative to | calcium | relative to | relative to | | | |
| | 100 parts | lactate | 100 parts | 100 parts | Evaluation | | |
| | by mass of | aqueous | by mass of | by mass of | Sensory | | |
| | raw rice | solution | boiled rice | raw rice | evaluation | | |
| Test Ex. | (part by | (% by | (part by | (part by | | Amount | Measurement |
| No. | mass) | mass) | mass) | mass) | Hardness | of water | Hardness (N) |
| 12-1 | — | — | — | — | 1.0 | C | 6.8 |
| 12-2 | 0.15 | 3.0 | 15.0 | 0.13 | 1.0 | C | 5.4 |

From the results of Text Example 12, it was found that when an alginate was brought into contact with rice beforehand and a polyvalent ion was subsequently brought into contact with the rice, cooked rice thus obtained was flaky and hard.

### Test Example 13

To raw rice (Akitakomachi) (100 parts by mass), water (135 parts by mass) was added. After the raw rice was immersed for 30 minutes, the raw rice was boiled in a rice cooker (in a “quick boiling” mode of an IH jar rice cooker (product No. SR-FD107) obtained from Panasonic Corporation). The rice was boiled in a manner that the amount of boiled rice relative to the raw rice would be 220% by mass.

To the boiled rice (100 parts by mass), a calcium lactate aqueous solution (10.0 ₚarts by mass) having a concentration of 4.0% by mass (the amount of calcium ion relative to 100 parts by mass of raw rice: 0.11 parts by mass), and an aqueous solution (10.0 parts by mass) in which the concentration of sodium alginate (KIMICA ALGINE I-3, obtained from KIMICA Corporation) was 2.0% by mass (the amount of alginate relative to 100 parts by mass of raw rice: 0.44 parts by mass) were added at the same time and mixed (Test Example 13-2). In a control, cooked rice was produced in the same manner except that calcium lactate and the alginate aqueous solution were not added (Test Example 13-1).

The obtained cooked rice (white rice) was stored at 3° C. for 2 days, and subsequently evaluated in the same manner as in Test Example 1. The results are presented in Table 12.

TABLE 12

| | | | | | Amount of | | | | |
|---|---|---|---|---|---|---|---|---|---|
| | | Amount of | | | alginate | | | | |
| | Concentration | calcium | Amount of | | aqueous | Amount of | | | |
| | of calcium | lactate | calcium ion | | solution | alginate | | | |
| | lactate in | relative to | relative to | Concentration | relative to | relative to | | | |
| | calcium | 100 parts by | 100 parts | of alginate in | 100 parts | 100 parts | Evaluation | | |
| | lactate | mass of | by mass of | alginate | by mass of | by mass of | Sensory | | |
| | aqueous | boiled rice | raw rice | aqueous | boiled rice | raw rice | evaluation | | |
| Test Ex. | solution | (part by | (part by | solution | (part by | (part by | | Amount | Measurement |
| No. | (% by mass) | mass) | mass) | (% by mass) | mass) | mass) | Hardness | of water | Hardness (N) |
| 13-1 | — | — | — | — | — | — | 1.0 | C | 6.3 |
| 13-2 | 4.0 | 10.0 | 0.11 | 2.0 | 10.0 | 0.44 | 1.0 | C | 5.3 |

From the results of Test Example 13, it was found that also when a polyvalent cation-containing liquid in which a polyvalent cation was formed and an alginate-containing liquid were added at the same time, cooked rice thus obtained was flaky and hard.

1. A method for keeping qualities of cooked rice, the method comprising:
bringing a polyvalent cation-containing liquid into contact with rice at any timing between before and after rice boiling or rice steaming; and
bringing an alginate-containing liquid into contact with the rice that contains a polyvalent cation and has been boiled or steamed.

2. The method for keeping qualities of cooked rice according to claim 1,
wherein the polyvalent cation-containing liquid is brought into contact with the rice during either or both of immersion and rice boiling.

3. The method for keeping qualities of cooked rice according to claim 1,
wherein the polyvalent cation-containing liquid contains a metal salt that is poorly water-soluble and forms a polyvalent cation at pH of 6.5 or lower, and
the polyvalent cation-containing liquid is brought into contact with the rice that has pH of 6.5 or lower and has been boiled or steamed.

4. The method for keeping qualities of cooked rice according to claim 3,
wherein the polyvalent cation-containing liquid and the alginate-containing liquid are one liquid.

5. The method for keeping qualities of cooked rice according to claim 1,
wherein with respect to 100 parts by mass of raw rice, an amount of the polyvalent cation is 0.01 parts by mass or greater, and an amount of an alginate is 0.01 parts by mass or greater.

6. The method for keeping qualities of cooked rice according to claim 1,
wherein from 1 part by mass to 50 parts by mass of the alginate-containing liquid is brought into contact with 100 parts by mass of the rice that has been boiled or steamed.

7. The method for keeping qualities of cooked rice according to claim 1,
wherein a concentration of an alginate in the alginate-containing liquid is from 0.05% by mass to 5% by mass.

8. A method for producing cooked rice, the method comprising:
bringing a polyvalent cation-containing liquid into contact with rice at any timing between before and after rice boiling or rice steaming; and
bringing an alginate-containing liquid into contact with the rice that contains a polyvalent cation and has been boiled or steamed.

9. The method for producing cooked rice according to claim 8,
wherein the polyvalent cation-containing liquid is brought into contact with the rice during either or both of immersion and rice boiling.

10. The method for producing cooked rice according to claim 8,
wherein the polyvalent cation-containing liquid contains a metal salt that is poorly water-soluble and forms a polyvalent cation at pH of 6.5 or lower, and
the polyvalent cation-containing liquid is brought into contact with the rice that has pH of 6.5 or lower and has been boiled or steamed.

11. The method for producing cooked rice according to claim 10,
wherein the polyvalent cation-containing liquid and the alginate-containing liquid are one liquid.

12. The method for producing cooked rice according to claim 8,
wherein with respect to 100 parts by mass of raw rice, an amount of the polyvalent cation is 0.01 parts by mass or greater, and an amount of an alginate is 0.01 parts by mass or greater.

13. The method for producing cooked rice according to claim 8,
wherein from 1 part by mass to 50 parts by mass of the alginate-containing liquid is brought into contact with 100 parts by mass of the rice that has been boiled or steamed.

14. The method for producing cooked rice according to claim 8,
wherein a concentration of an alginate in the alginate-containing liquid is from 0.05% by mass to 5% by mass.

15. The method for keeping qualities of cooked rice according to claim 2,
wherein with respect to 100 parts by mass of raw rice, an amount of the polyvalent cation is 0.01 parts by mass or greater, and an amount of an alginate is 0.01 parts by mass or greater.

16. The method for keeping qualities of cooked rice according to claim 3,
wherein with respect to 100 parts by mass of raw rice, an amount of the polyvalent cation is 0.01 parts by mass or greater, and an amount of an alginate is 0.01 parts by mass or greater.

17. The method for keeping qualities of cooked rice according to claim 16,
wherein the polyvalent cation-containing liquid and the alginate-containing liquid are one liquid.

18. The method for producing cooked rice according to claim 9,
wherein with respect to 100 parts by mass of raw rice, an amount of the polyvalent cation is 0.01 parts by mass or greater, and an amount of an alginate is 0.01 parts by mass or greater.

19. The method for producing cooked rice according to claim 10,
wherein with respect to 100 parts by mass of raw rice, an amount of the polyvalent cation is 0.01 parts by mass or greater, and an amount of an alginate is 0.01 parts by mass or greater.

20. The method for producing cooked rice according to claim 19, wherein the polyvalent cation-containing liquid and the alginate-containing liquid are one liquid.
